(19) United States
(12) Patent Application Publication
(10) Pub. No.: US 2026/0222077 A1
(43) Pub. Date: Jul. 30, 2026

(54) ADAPTIVE EQUALIZATION CIRCUIT, ADAPTIVE EQUALIZATION DEVICE, RECEIVER, AND ADAPTIVE EQUALIZATION METHOD

(71) Applicant: NTT Innovative Devices Corporation, Yokohama-shi, Kanagawa (JP)

(72) Inventors: Tomohiro TAKAMUKU, Kanagawa (JP); Mitsuteru YOSHIDA, Kanagawa (JP); Katsuichi OYAMA, Kanagawa (JP); Hiroyuki NOUCHI, Kanagawa (JP); Tomoharu SEMBOKU, Kanagawa (JP)

(73) Assignee: NTT Innovative Devices Corporation, Yokohama-shi, Kanagawa (JP)

(21) Appl. No.: 19/147,369

(22) PCT Filed: Dec. 20, 2023
(86) PCT No.: PCT/JP2023/045730

§ 371 Date: Jul. 11, 2025

(30) Foreign Application Priority Data
Jan. 30, 2023 (JP) 2023-011545

(51) Int. Cl. H04B 10/61; H04B 3/10

(52) U.S. Cl. CPC H04B 10/6161; H04B 3/10

(57) ABSTRACT

An adaptive equalization device includes: adaptive equalization circuitry, decoding circuitry including a frame synchronizing circuitry; and pseudo-frame signal generation circuitry generating a pseudo-frame signal, wherein a frame initially generated is the pseudo-frame signal generated by the pseudo-frame signal generation circuitry, the pseudo-frame signal is used as a trigger to start operation of the adaptive equalization circuitry and as a reference signal when performing signal processing in the decoding circuitry, the adaptive equalization circuitry includes a digital filter compensating for polarization fluctuation of at least two polarization data using a filter with tap coefficients set, and tap coefficient update circuitry, a synchronization pattern is inserted in a head of each frame of the polarization data as a known signal a pilot signal is inserted in a head of each subframe constituting the frame of the polarization data as a known signal.

### FIELD

The present disclosure relates to an adaptive equalization circuit, an adaptive equalization device, a receiver, and an adaptive equalization method which compensate for characteristics of an optical transmission line in data communication.

### BACKGROUND ART

In coherent optical communication, large-capacity transmission of several tens of Gbit/s or more is achieved by compensating for distortions in a transmission signal on a receiving side through digital signal processing. Digital signal processing mainly involves processing such as chromatic dispersion compensation, frequency control and phase adjustment, polarization division multiplexing, and polarization dispersion compensation.

Processing of polarization division multiplexing and polarization dispersion compensation is mainly performed by an adaptive equalizer. When an adaptive equalizer is realized by digital signal processing, a digital filter is typically used. Setting tap coefficients calculated to cancel out a distortion of a transmission signal to the digital filter enables the distortion of the transmission signal to be compensated for.

In a receiving optical module, an X-polarized signal (hereinafter referred to as X polarization) and a Y-polarized signal (hereinafter referred to as Y polarization) synthesized on a transmitting side are separated. A portion of the Y polarization remains in the separated X polarization and a portion of the X polarization remains in the separated Y polarization. A digital filter in the adaptive equalizer provides more complete separation between data of the X polarization and data of the Y polarization. However, the polarization dispersion and the like described above are affected by fluctuations in a polarization state. Therefore, the tap coefficients of the digital filter are successively updated in accordance with a fluctuation of the polarization state and compensation that follows the fluctuation is performed.

A sequential update algorithm such as RLS (Recursive Least-Squares) or LMS (Least Mean Square) is generally used to update the tap coefficients of such digital filters. This is an algorithm in which a known signal such as a training signal or a pilot signal is inserted into an optical signal on the transmitting side, and the tap coefficients are obtained by updating the tap coefficients for each step size so as to minimize an error between the transmitted known signal and a true value of the known signal (the value inserted on the transmitting side) (hereinafter referred to as a reference signal comparison equalization method).

As the known signal to be compared as described above, a relatively long training signal (TS) pattern (for example, 128, 256, or 512 symbols inserted every tens of thousands of symbols of data) set for frame synchronization and a relatively short pilot signal (PS) set for phase synchronization (for example, one to several symbols inserted every few dozen symbols) are used. For example, a TS pattern indicating the head of a frame is detected and used to obtain initial tap coefficients. Subsequently, a regularly inserted PS is detected from a location of the TS pattern and used to obtain sequential tap coefficients.

However, since the TS pattern is relatively long, an amount of operations required to detect the TS pattern is large, and since even a short TS pattern has an impact on the amount of data, new communication systems are being developed to either omit the TS pattern or make it as short as possible.

In order to accommodate such systems, blind equalization methods are used as a sequential update algorithm in adaptive equalizers to obtain tap coefficients without using known signals. Examples of blind equalization methods include the Constant Modulus Algorithm (CMA) and the Radius Directed Equalization (RDE) which extends CMA to rings of a plurality of amplitudes for use in Quadrature Amplitude Modulation (QAM) (for example, refer to PTL 1 and 2). In these methods, the tap coefficients are updated to minimize the error between an output of the digital filter and an ideal value of the output (the “ideal value” can be easily estimated as a desired value of amplitude in the case of a constant envelope). The tap coefficients are controlled and caused to converge according to this algorithm. RDE adds the ability to determine any of the plurality of amplitudes to CMA.

### CITATION LIST

### Patent Literature

[PTL 1] JP 2017-225078 A
[PTL 2] JP 2020-17809 A

### SUMMARY OF THE INVENTION

### Problems to be Solved by the Invention

In recent years, signals with extremely short TS patterns have been used and adaptive equalizers that operate in blind equalization methods such as an RDE mode have become more common. However, conventional adaptive equalizers adopting blind equalization methods have a problem in that their immunity to noise, polarization fluctuation, and a DGD (Differential Group Delay) load is inferior as compared to adaptive equalizers that update tap coefficients by comparing them with a known signal such as a TS pattern or a PS. The DGD load refers to the delay difference between the X-polarized signal and the Y-polarized signal.

The present disclosure has been made in order to solve problems as described above and an object thereof is to obtain an adaptive equalization circuit, an adaptive equalization device, a receiver, and an adaptive equalization method that can suppress degradation of immunity even when a signal with no TS pattern or a signal that is as short as possible is used.

### Solution to Problem

An adaptive equalization circuit according to the present disclosure includes: a digital filter compensating for polarization fluctuation of at least two polarization data in which a plurality of known signals are inserted in respective frames at predetermined locations, using a filter with tap coefficients set; and a tap coefficient update circuit, wherein before a frame synchronizing unit generates a frame signal from an output signal of the digital filter, the tap coefficient update circuit obtains the tap coefficients so that a difference between an amplitude value of the data and an amplitude value that the data is expected to assume becomes smaller, and after the frame signal is generated, the tap coefficient update circuit receives the frame signal as feedback, detects the known signal from the data based on the frame signal, and updates the tap coefficients so that a difference between the detected known signal and the true value of the known signal becomes smaller.

### Advantageous Effects of Invention

In the present disclosure, even in a case using a signal that does not contain a TS pattern or a signal made as short as possible, degradation of immunity can be suppressed.

### BRIEF DESCRIPTION OF THE DRAWINGS

FIG. 1 is a configuration diagram illustrating a receiver according to an embodiment.

FIG. 2 is a diagram illustrating a configuration of a data frame of a transmitted signal used in an optical communication system.

FIG. 3 is a configuration diagram illustrating an adaptive equalization device according to the embodiment.

FIG. 4 is a diagram illustrating a relationship between a received signal and a frame signal.

FIG. 5 is a diagram illustrating a digital filter.

FIG. 6 is a configuration diagram illustrating a decoding circuit.

FIG. 7 is a diagram for describing an XY polarization swapping operation.

FIG. 8 is a diagram for describing a compensation operation of an XY inter-polarization skew.

FIG. 9 is a diagram for describing an IQ swap.

FIG. 10 is a diagram for describing an IQ swap.

FIG. 11 is a flowchart illustrating operations of the adaptive equalization device according to the embodiment.

### DESCRIPTION OF EMBODIMENTS

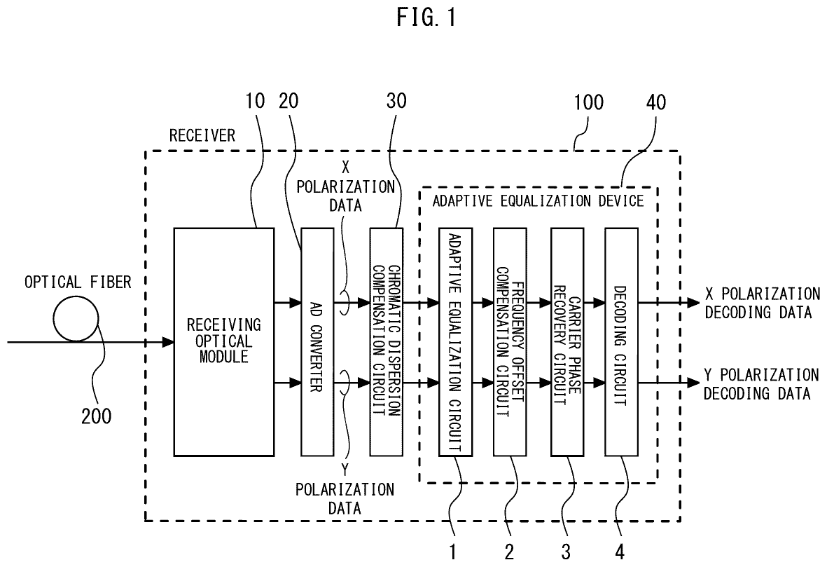

FIG. 1 is a configuration diagram illustrating a receiver according to an embodiment. A receiver 100 includes a receiving optical module 10, an A/D converter 20, a chromatic dispersion compensation circuit 30, and an adaptive equalization device 40. The adaptive equalization device 40 includes an adaptive equalization circuit 1, a frequency offset compensation circuit 2, a carrier phase recovery circuit 3, and a decoding circuit 4.

Although not illustrated in the drawing, in a transmitter, transmission data is divided into transmission data for X polarization and transmission data for Y polarization, which modulate an X-polarized optical signal and a Y-polarized optical signal, respectively. The modulated X-polarized optical signal and Y-polarized optical signal are combined and supplied to the receiver 100 via an optical fiber 200 as a received signal.

The receiving optical module 10 separates the received signal into an X-polarized optical signal and a Y-polarized optical signal and converts the separated signals into electrical signals. The A/D converter 20 converts the output signals of the receiving optical module 10 into X polarization data and Y polarization data, respectively. The chromatic dispersion compensation circuit 30 performs chromatic dispersion compensation processing on the X polarization data and the Y polarization data and compensates for distortion caused by chromatic dispersion of the data.

The adaptive equalization circuit 1 further polarizes and separates the output signals of the chromatic dispersion compensation circuit 30 and subjects the output signals to polarization dispersion compensation processing to compensate for polarization fluctuation. Since circumstances of polarization separation and polarization dispersion change sequentially due to polarization fluctuations in the optical fiber 200, the tap coefficients of the digital filter in the adaptive equalization circuit 1 are updated to follow the polarization fluctuations.

The frequency offset compensation circuit 2 compensates for frequency errors in the carrier signal between the transmitter and the receiver 100 for X polarization data and Y polarization data, respectively. The carrier phase recovery circuit 3 compensates for phase errors in the carrier signal between the transmitter and the receiver 100 for X polarization data and Y polarization data, respectively.

The decoding circuit 4 performs frame synchronization for each of the X polarization data and the Y polarization data from the carrier phase recovery circuit 3 and, at the same time, compares the X polarization data and the Y polarization data to check adequacy of a polarization separation state, a received phase relationship on an IQ plane, and the like. After performing error correction processing, the decoding circuit 4 finally outputs X polarization decoding data and Y polarization decoding data of “0” and “1”.

Note that the X polarization data and the Y polarization data are transmitted in parallel between each circuit of the receiver 100. In practice, however, processing is performed by dividing each piece of data into I data that is a real component and Q data that is an imaginary component on the IQ plane. In other words, X polarization data is processed in sets of (X_I, X_Q), and Y polarization data is processed in sets of (Y_I, Y_Q). Although a case of two pieces of polarization data of X polarization and Y polarization as polarization data as an example of typical optical communication will be described in the present specification, the present embodiment is not necessarily limited to a case of two polarizations and can also be applied to a case where three or more polarizations are enabled.

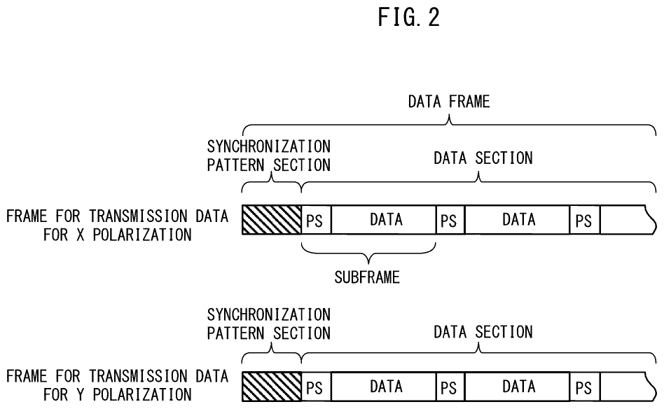

FIG. 2 is a diagram illustrating a configuration of a data frame of a transmitted signal used in an optical communication system. The present data frame is constructed in each of the transmission data for X polarization and the transmission data for Y polarization described above. Each data frame contains a synchronization pattern section and a data section. In the present optical communication system, the synchronization pattern section is constituted of around several to several dozen symbols.

In a typical optical communication system transmission packet such as OTN (Optical Transport Network), a training sequence (TS) pattern of several hundred known symbols (for example, 128 symbols, 256 symbols, or 512 symbols) are added to every or every few OTUs (Optical-channel Transport units: each several tens of thousands of symbols). The TS pattern is detected by a circuit at a stage preceding the adaptive equalization circuit 1 and is used to synchronize the OTU frame and to update the tap coefficients of the adaptive equalization circuit 1. As a tap coefficient update algorithm of the adaptive equalization circuit 1, a sequential update algorithm of a reference signal comparison equalization method such as RLS (Recursive Least-Squares) or LMS (Least Mean Square) which obtains tap coefficients by comparison with a known signal is used. In RLS and LMS, the tap coefficients are updated so as to minimize a difference between a received known signal (TS signal) and a true value of the known signal.

On the other hand, in the present optical communication system, long patterns such as the TS pattern described above are not used and only short synchronization patterns of about several dozen symbols (for example, 16 symbols) are added. Synchronization patterns are not used for tap coefficient updating. Since there is no long reference signal such as the TS pattern to compare at least at the start of reception of a received signal, a blind equalization method that seeks a tap coefficient so as to minimize an error between an amplitude of the received signal and its desired value is used as the tap coefficient update algorithm of the adaptive equalization circuit 1. Examples of blind equalization methods include the Constant Modulus Algorithm (CMA) and the Radius Directed Equalization (RDE) which extends CMA to rings of a plurality of amplitudes for use in Quadrature Amplitude Modulation (QAM).

In addition, in the data section, the transmission data for X polarization is divided into a plurality of subframes and set for a frame for the transmission data for X polarization and the transmission data for Y polarization is divided into a plurality of subframes and set for a frame for the transmission data for Y polarization. For example, each subframe can be set to several tens to several hundreds of symbols. Furthermore, at the head of each subframe is a known signal with a pilot signal (PS) of one to several symbols inserted. Therefore, PSs are inserted into data at constant symbol intervals (subframe intervals). PSs are usually all set to the same amplitude. In other words, a plurality of known signals are inserted in each frame of data at predetermined locations. Note that PSs are also regularly inserted into the data in the typical optical communication system described above.

Note that, in a typical optical communication system, initial values of the tap coefficients of the adaptive equalization circuit 1 are obtained by the TS pattern using the reference signal comparison equalization method and the tap coefficients of the adaptive equalization circuit 1 are successively updated by the regularly inserted PS using the reference signal comparison equalization method.

Each of the synchronization pattern section and the PS may be different or the same between the frame of transmission data for X polarization and the frame of transmission data for Y polarization. However, the synchronization pattern section is generally set up with different patterns to distinguish between X polarization and Y polarization. In addition, the PS is also generally set up with a different pattern to prevent the tap coefficients from converging to the same polarization side (such as the taps for the Y polarization side also erroneously converging to the X polarization side).

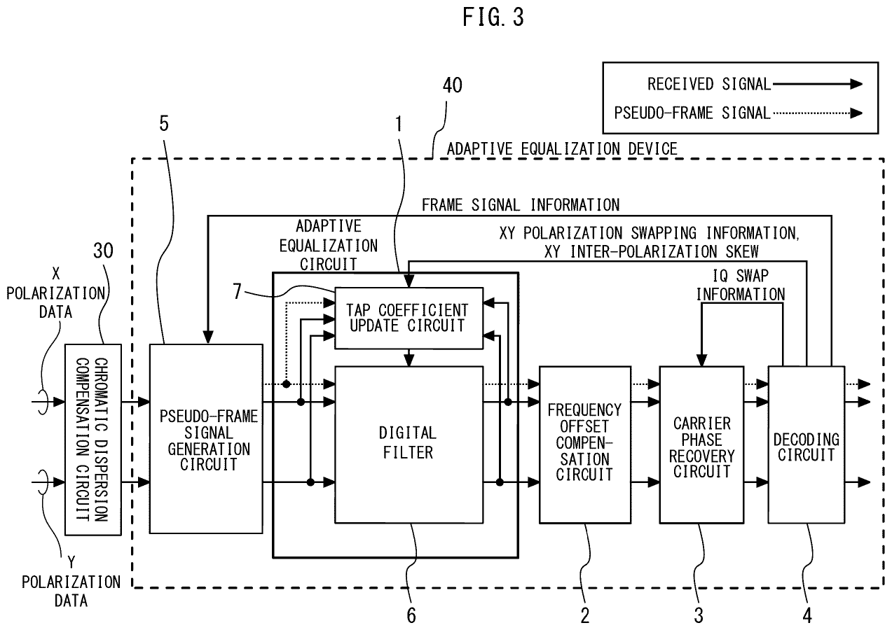

FIG. 3 is a configuration diagram illustrating an adaptive equalization device according to the embodiment. The adaptive equalization device 40 includes a pseudo-frame signal generation circuit 5, the adaptive equalization circuit 1, the frequency offset compensation circuit 2, the carrier phase recovery circuit 3, and the decoding circuit 4. X polarization data and Y polarization data from the chromatic dispersion compensation circuit 30 is supplied to the pseudo-frame signal generation circuit 5. The pseudo-frame signal generation circuit 5 generates a temporary frame signal (referred to as a pseudo-frame signal) at the start of reception of the received signal. The adaptive equalization circuit 1 includes a digital filter 6 and a tap coefficient update circuit 7.

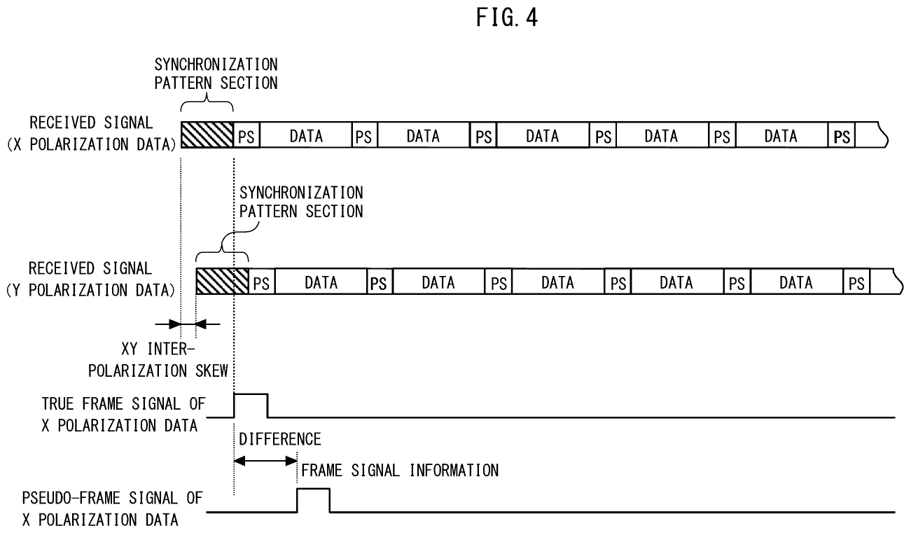

FIG. 4 is a diagram illustrating a relationship between a received signal and a frame signal. The pseudo-frame signal generation circuit 5 optionally generates one pseudo-frame signal with respect to the received X polarization data and Y polarization data. The X polarization data and the Y polarization data are not necessarily received at the same time. A temporal difference between the X polarization data and the Y polarization data is referred to as an XY inter-polarization skew.

The X polarization data and the Y polarization data supplied from the chromatic dispersion compensation circuit 30 is not processed by the pseudo-frame signal generation circuit 5 but are supplied together with the pseudo-frame signal to the adaptive equalization circuit 1 in a next stage. The X polarization data and the Y polarization data subjected to adaptive equalization processing in the adaptive equalization circuit 1 are supplied together with the pseudo-frame signal to the decoding circuit 4 via the frequency offset compensation circuit 2 and the carrier phase recovery circuit 3. At the start of reception of the received signal, tap coefficient updates of the adaptive equalization circuit 1 is performed by a blind equalization method.

The pseudo-frame signal that is initially generated by the pseudo-frame signal generation circuit 5 is used as a trigger to start operation of the adaptive equalization circuit 1 and as a reference signal when performing frame synchronization processing and various kinds of signal processing in the decoding circuit 4 in a subsequent stage. The decoding circuit 4 performs various kinds of processing based on the pseudo-frame signal. As will be described later, the decoding circuit 4 detects a true frame signal from the X polarization data and the Y polarization data. Typically, a frame signal detected from the X polarization data is used as the “true frame signal”. An XY inter-polarization skew is obtained from a difference between frame signals detected from the X polarization data and the Y polarization data. The XY inter-polarization skew is fed back to the adaptive equalization circuit 1.

The true frame signal detected based on the X polarization data includes a temporal difference with respect to the pseudo-frame signal. The temporal difference can be represented as a symbol amount. The difference is fed back as frame signal information from the decoding circuit 4 to the pseudo-frame signal generation circuit 5. Based on the frame signal information, the pseudo-frame signal generation circuit 5 corrects the pseudo-frame signal to the true frame signal. Note that even if no actual correction is made, a substantial correction can be made by communicating correction information to each circuit.

The pseudo-frame signal corrected to the true frame signal is supplied to the adaptive equalization circuit 1 together with the X polarization data and the Y polarization data. The adaptive equalization circuit 1 first compensates for the XY inter-polarization skew with the tap coefficients of the digital filter 6. In other words, the tap coefficients of the digital filter 6 are corrected so that the XY inter-polarization skew becomes zero. Subsequently, the decoding circuit 4 synchronizes again and confirms that positions of the corrected pseudo-frame signal coming from the adaptive equalization circuit 1 and the true frame signal detected by the decoding circuit 4 are not misaligned and that the XY inter-polarization skew detection value is also zero. Accordingly, a PS can be detected as a known signal from the true frame signal. Using the PS as a known signal, a transition is subsequently made to a tap coefficient update mode in a reference signal comparison equalization method.

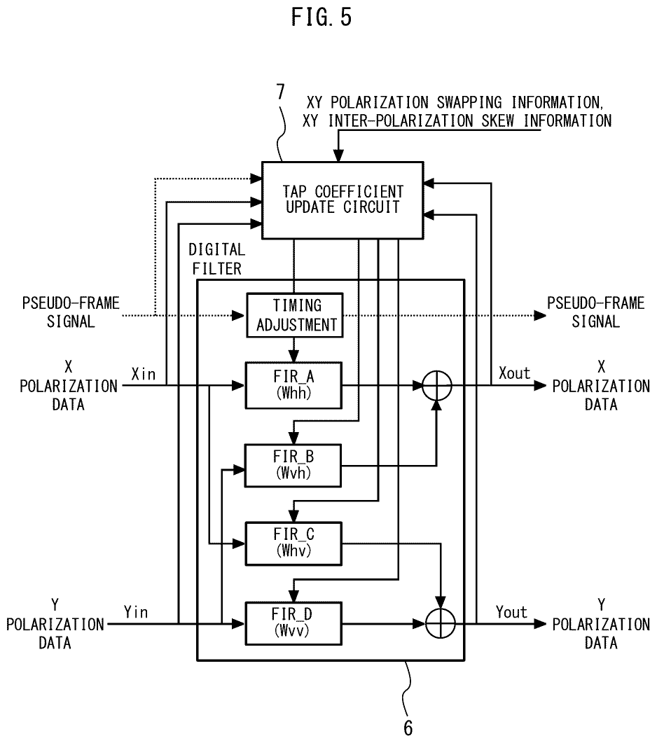

FIG. 5 is a diagram illustrating a digital filter. The digital filter 6 includes FIR (Finite Impulse Response) filters FIR_A, FIR_B, FIR_C, and FIR_D constructed in a butterfly shape. FIR_A is a filter with respect to X polarization data. FIR_B is a filter with respect to the effect of Y polarization data to X polarization data. FIR_C is a filter with respect to the effect of X polarization data to Y polarization data. FIR_D is a filter with respect to Y polarization data. Each FIR filter includes N-number of taps. However, the numbers of taps of the FIR filters may differ from one another.

The digital filter 6 adopts a sum of a filtering result of FIR_A with respect to the X polarization data and a filtering result of FIR_B with respect to Y polarization data as a compensation output of X polarization data and adopts a sum of a filtering result of FIR_C with respect to X polarization data and a filtering result of FIR_D with respect to Y polarization data as a compensation output of Y polarization data. These compensation outputs ensure polarization separation with greater certainty.

In addition, a relationship between the input/output data and the tap coefficients of each filter is shown below.

$$Xout = Whh \cdot Xin + Wvh \cdot Yin$$

$$Yout = Whv \cdot Xin + Wvv \cdot Yin$$

In the equations, Xin denotes input data of X polarization data. Yin denotes input data of Y polarization data. Xout denotes output data of X polarization data. Yout denotes output data of Y polarization data. Whh denotes a series of tap coefficients of the filter FIR_A. Wvh denotes a series of tap coefficients of the filter FIR_B. Whv denotes a series of tap coefficients of the filter FIR_C. Wvv denotes a series of tap coefficients of the filter FIR_D.

The tap coefficients Whh, Why, Why, and Wvv are obtained by the sequential update algorithm of the tap coefficient update circuit 7. The sequential update algorithm is generally expressed by the following equations.

$$Whh ( n + 1 ) = Whh ( n ) + μ eX ( n ) Xout ( n ) - {Xin}^{*} ( n )$$

$$Wvh ( n + 1 ) = Wvh ( n ) + μ eX ( n ) Xout ( n ) \cdot {Yin}^{*} ( n )$$

$$Whv ( n + 1 ) = Whv ( n ) + μ eY ( n ) Yout ( n ) \cdot {Xin}^{*} ( n )$$

$$Wvv ( n + 1 ) = Wvv ( n ) + μ eY ( n ) Yout ( n ) \cdot {Yin}^{*} ( n )$$

In the equations, n denotes a value indicating an update order in the sequential update algorithm. The tap coefficient Whh(n) denotes a tap coefficient group of FIR_A in a case of the update order n. The tap coefficient Wvh(n) denotes a tap coefficient group of FIR_B in a case of the update order n. The tap coefficient Whv(n) denotes a tap coefficient group of FIR_C in a case of the update order n. The tap coefficient Wvv(n) denotes a tap coefficient group of FIR_D in a case of the update order n. μ denotes a step size of the update algorithm. eX(n) denotes an error from a desired value in the filter output of X polarization data. eY(n) denotes an error from the desired value in the filter output of Y polarization data. The desired value is a reference signal in the case of a reference signal comparison equalization method and an amplitude value to be assumed in a blind equalization method.

Xout(n) denotes a filter output with respect to X polarization data in the case of the update order n. Xin(n) denotes a filter input with respect to X polarization data in the case of the update order n. Yout(n) denotes a filter output with respect to Y polarization data in the case of the update order n. Yin(n) denotes a filter input with respect to Y polarization data in the case of the update order n. * denotes a conjugate or a complex conjugate. Note that data and tap coefficients are represented by complex numbers.

The sequential update algorithm causes the update of the tap coefficients to iteratively converge so that the errors described above are minimized. Since the reference signal comparison equalization method compares not only the amplitude value but also the phase as a reference signal, the method can provide more accurate equalization compensation than the blind equalization method that compares only the amplitude value. In addition, even when blind equalization of modulation methods that can assume a plurality of amplitudes is performed using a sequential update algorithm such as RDE that does not use phase information, it is possible to switch to a CMA method that does not require amplitude determination and, consequently, determination errors can be prevented and highly accurate adaptive equalization compensation can be performed. Note that the equations described above are examples of equations that represent a sequential update algorithm and equations that represent a sequential update algorithm are not limited to the equations described above.

With the sequential update algorithm described above, the tap coefficients are updated sequentially in the update order n so that the errors between the filter outputs and the desired values are minimized, and finally the tap coefficients converge. Conditions for convergence are determined by the number of times in the update order n, the error between the filter output and the desired value, or the like. In addition, the tap coefficient update circuit 7 determines the tap coefficients based on XY polarization swapping information and XY inter-polarization skew information detected by the decoding circuit 4 to compensate for signal degradation caused by the switching and skew.

Returning to FIG. 3, an operation of each circuit will be described. The FIR filters FIR_A, FIR_B, FIR_C, and FIR_D constructed in a butterfly shape illustrated in FIG. 5 subject the X polarization data and the Y polarization data supplied to the adaptive equalization circuit 1 to polarization separation processing and polarization dispersion compensation processing. At this point, the pseudo-frame signal supplied from the pseudo-frame signal generation circuit 5 is not subjected to adaptive equalization processing and only the timing is adjusted before being output to a circuit at a later stage. The tap coefficients of each FIR filter are obtained by the sequential update algorithm in the tap coefficient update circuit 7.

In the present optical communication system, since a TS pattern is not set at the head of a data frame as illustrated in FIG. 2, a frame signal cannot be detected using a TS pattern. Therefore, a head position of the data frame is unknown and a PS inserted in the data section cannot be detected. In this situation, the reference signal comparison equalization method cannot be used as a sequential update algorithm. In consideration thereof, at the start of reception of the received signal, the tap coefficient update circuit 7 updates the tap coefficients of the digital filter 6 using a blind equalization method such as CMA and RDE as the sequential update algorithm. While the tap coefficient update algorithm based on the blind equalization method is somewhat inferior to the reference signal comparison equalization method in terms of noise immunity, polarization separation immunity, DGD immunity, and the like, it can compensate to a level where signal points can be detected on the IQ plane. The frequency offset compensation circuit 2 performs further frequency offset compensation on the X polarization data and the Y polarization data that have been subjected to adaptive equalization processing by the adaptive equalization circuit 1. The carrier phase recovery circuit 3 performs phase synchronization between IQ axes of the data and IQ axes of the carrier signal. Note that the adaptive equalization circuit 1 can use the pseudo-frame signal to learn about the start of reception of the received signal.

Next, the decoding circuit 4 performs frame synchronization and state detection. Frame synchronization enables a true frame signal to be detected from the X polarization data and the Y polarization data. After the true frame signal is generated, the pseudo-frame signal generation circuit 5 receives feedback of information about the true frame signal (actually, a temporal difference from the pseudo-frame signal) and corrects the pseudo-frame signal to the true frame signal. The tap coefficient update circuit 7 detects the head position of the frame using the true frame signal which is the corrected pseudo-frame signal, and detects the PS regularly inserted in the data section based on the head position. In state detection, information on an IQ swap is detected.

After the PS is detected, the tap coefficient update circuit 7 executes the tap coefficient update algorithm of the reference signal comparison method which uses the PS as a reference signal. Since the PS is regularly inserted into the data section, the tap coefficients are also sequentially updated by the PS. At this point, the tap coefficient update algorithm is switched from the blind equalization method to the reference signal comparison method. Switching to the reference signal comparison method using the PS improves noise immunity, polarization separation immunity, DGD immunity, and the like. Accordingly, even in an optical communication system using a signal that does not contain a TS pattern or a signal made as short as possible, adaptive equalization processing such as polarization separation processing and polarization dispersion compensation processing can be performed without degrading noise immunity, polarization separation immunity, DGD immunity, and the like.

The embodiment described above shows that a blind equalization method based on CMA (during QPSK) or RDE (during QAM) is used before detection of a PS as a tap coefficient update algorithm and that a switch is made to a reference signal comparison method using a PS signal as a reference signal after detection of a PS. However, after the detection of a PS, the method is not limited to the reference signal comparison method and a blind equalization method based on CMA using the PS or a hybrid method using both a blind equalization method based on CMA using the PS and a blind equalization method based on RDE using data can also be used. Even in such cases, noise immunity, polarization separation immunity, DGD immunity, and the like can be improved as compared to a case where only a blind equalization method based on RDE using data is applied.

In addition, in the embodiment described above, information on a true frame signal detected by the decoding circuit 4 is fed back to the pseudo-frame signal generation circuit 5 where the pseudo-frame signal is corrected to the true frame signal and used by the tap coefficient update circuit 7. However, the information of the true frame signal can be directly fed back to the tap coefficient update circuit 7 to correct the pseudo-frame signal for use.

The X polarization data and the Y polarization data subjected to polarization separation processing and polarization dispersion compensation processing in the adaptive equalization circuit 1 are next supplied to the frequency offset compensation circuit 2. The frequency offset compensation circuit 2 compensates for a frequency error (frequency offset) between a carrier of the transmitter and a carrier of the receiver 100 with respect to each of the X polarization data and the Y polarization data. This can be easily compensated by applying a phase rotation opposite to a phase rotation corresponding to the frequency error with respect to data on the IQ plane. The frequency offset compensation can be executed by a complex multiplication of the phase rotation to coordinate values of the data or by using the carrier phase recovery circuit 3.

Next, the carrier phase recovery circuit 3 synchronizes a phase of received data with a phase of the carrier with respect to each of the X polarization data and the Y polarization data. Specifically, an I axis and a Q axis of the IQ plane of the received data are synchronized with an I axis and a Q axis of the carrier. Accordingly, a coordinate value (signal point) of received data on the IQ plane of the carrier can be detected. Note that the synchronization creates four uncertainties of 90 degrees each, such that coordinates in the original first quadrant are detected as coordinates in the second to fourth quadrants.

A general method of carrier phase recovery is disclosed in PTL 2. The present literature discloses a method of performing phase synchronization based on a phase difference between a known pattern and its true value (known-pattern comparison type) and a method of performing phase synchronization by removing a modulation component by multiplying a received signal by M when the number of modulation phases is M (M-multiply type). With the known-pattern comparison type, the uncertainties described above can be eliminated and accurate phase synchronization can be performed. With the M-multiply type, although the uncertainties remain, phase synchronization can be performed even if known patterns are undetected.

In the present system, since a true frame signal is not generated at the start of reception of the received signal, a PS that is a known pattern cannot be detected and carrier phase recovery of the known-pattern comparison type which is based on the PS cannot be performed. Therefore, initially, the M-multiply type phase synchronization described above is performed. In this case, even with the quadrant uncertainties described above, phase synchronization within a quadrant is possible because the four quadrants are superimposed on a single quadrant.

Once the true frame signal is detected by the decoding circuit 4, phase synchronization of the known-pattern comparison type can be performed using the PS detected based on the frame signal. However, depending on implementation configuration of a modulator on the transmitting side and the receiver 100 on the receiving side, an inversion of a sign or IQ coordinates may occur in a known pattern that can be observed on the receiving side with respect to a known pattern inserted on the transmitting side. This would be problematic in phase synchronization of the known-pattern comparison type using a PS.

In consideration thereof, a state detecting unit of the decoding circuit 4 to be described later obtains IQ swap information. The IQ swap information is to be information that indicates whether the sign or the I coordinate and the Q coordinate are swapped. For example, if an IQ swap of carriers occurs (when positive and negative of the I axis is inverted) when (I coordinate, Q coordinate)=(+1, +1) (first quadrant), (I coordinate, Q coordinate)=(−1, +1) (second quadrant), (I coordinate, Q coordinate)=(−1, −1) (third quadrant), (I coordinate, Q coordinate)=(+1, −1) (fourth quadrant) and a PS that transitions counterclockwise are sent as transmitted PS data, the received coordinate values are (I coordinate, Q coordinate)=(+1, +1) (first quadrant), (I coordinate, Q coordinate)=(+1, −1) (fourth quadrant), (I coordinate, Q coordinate)=(−1, −1) (third quadrant), (I coordinate, Q coordinate)=(−1, +1) (second quadrant) and the transition is clockwise. In the decoding circuit 4, after the true frame position is detected, the state detecting unit obtains information on the IQ swap described above.

Based on the IQ swap information, the coordinate values of the reference signal on the receiving side are corrected to perform phase synchronization of the known-pattern comparison type. In other words, the carrier phase recovery circuit 3 performs phase synchronization of the M-multiply type at the start of reception of the received signal, and after the true frame signal is detected, the carrier phase recovery circuit 3 obtains IQ swap information from state detection and performs phase synchronization of the known-pattern comparison type by converting the reference coordinates of a PS based on the IQ swap information.

As described above, at the start of reception of the received signal, the adaptive equalization circuit 1 operates in the blind equalization method and the carrier phase recovery circuit 3 operates in the M-multiply type phase synchronization method. Accordingly, a true frame signal is generated by the decoding circuit 4. Therefore, a position of a PS can be comprehended without having to provide a received signal with a function for detecting frame synchronization. The adaptive equalization circuit 1 can use the detected PS as a reference signal to make a transition to an accurate coefficient update method, and the carrier phase recovery circuit 3 can use the detected PS as a known signal to make a transition to an accurate phase synchronization method of the known-pattern comparison type.

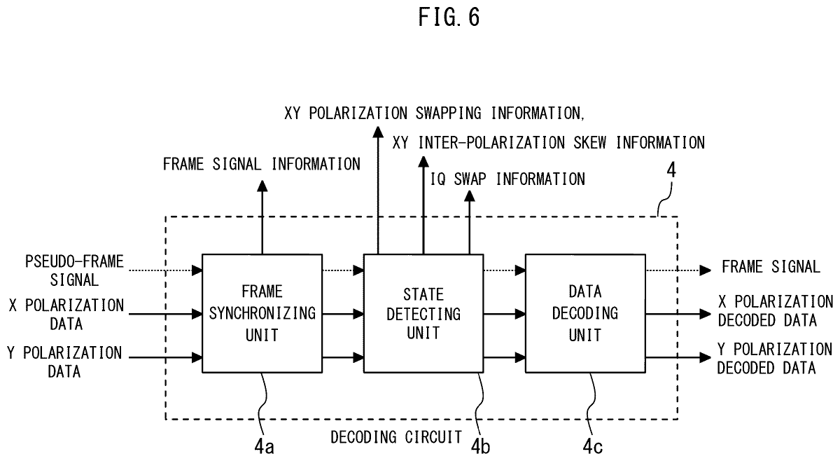

The decoding circuit 4 performs frame synchronization, state detection, and data decoding with respect to X polarization data and Y polarization data. FIG. 6 is a configuration diagram illustrating a decoding circuit. The decoding circuit 4 includes a frame synchronizing unit 4a, a state detecting unit 4b, and a data decoding unit 4c.

At the start of reception of the received signal, the frame synchronizing unit 4a performs frame synchronization with respect to X polarization data and Y polarization data based on the pseudo-frame signal generated by the pseudo-frame signal generation circuit 5. In other words, a frame signal indicating a frame of the X polarization data and a frame signal indicating a frame of the Y polarization data are generated. Accordingly, a true frame signal is detected. As illustrated in FIG. 4, the true frame signal is, in principle, a frame signal generated based on the X polarization data. However, when there is a skew (delay difference) between the X polarization data and the Y polarization data, the state detecting unit 4b detects the skew between the polarizations from an output signal of the frame synchronizing unit 4a as XY inter-polarization skew information. The delay difference is fed back to the adaptive equalization circuit 1 to be compensated. After the compensation, a frame signal generated based on the Y polarization data also approaches the true frame signal.

A temporal difference between the true frame signal and the pseudo-frame signal is fed back to the pseudo-frame signal generation circuit 5 as frame signal information, the pseudo-frame signal is corrected based on the frame signal information, and a true frame signal is generated. Substantially, the pseudo-frame signal and the frame signal information are transmitted, and each circuit generates a timing of the true frame signal from both the pseudo-frame signal and the frame signal information. In addition, since a head position of the data section can be detected from the true frame signal, a PS inserted into data at constant symbol intervals can be detected on the transmitting side. The PS is a known signal.

Therefore, after the frame signal information is fed back to the pseudo-frame signal generation circuit 5, as described above, the adaptive equalization circuit 1 switches from a tap coefficient update algorithm of the blind equalization method to a tap coefficient update algorithm of the reference signal comparison method using a PS as a reference signal, and the carrier phase recovery circuit 3 switches from phase synchronization of the M-multiply type to phase synchronization of the known-pattern comparison type.

The state detecting unit 4b detects XY polarization swapping information and XY inter-polarization skew information from the output signal of the frame synchronizing unit 4a and detects IQ swap information for each piece of polarization data. The XY polarization swapping information and the XY inter-polarization skew information are fed back to the tap coefficient update circuit 7 of the adaptive equalization circuit 1. The IQ swap information is fed back to the carrier phase recovery circuit 3. The pieces of information can be independently detected and fed back. Not all of the information needs necessarily be fed back. Therefore, the state detecting unit 4b can be divided depending on the information to be detected. For example, the state detecting unit 4b can be divided into a first portion that detects XY polarization swapping information and XY inter-polarization skew information and a second portion that detects IQ swap information.

The XY polarization swapping information can be determined when establishing frame synchronization in the frame synchronizing unit 4a. Essentially, when a synchronization pattern inserted into X polarization data is detected in a lane of Y polarization data or a synchronization pattern inserted into Y polarization data is detected in a lane of X polarization data, it can be determined that XY polarizations have been swapped as XY polarization swapping information. The adaptive equalization circuit 1 receives feedback of the XY polarization swapping information and compensates for polarization swapping of XY polarization data by adjusting the tap coefficients of the filters based on the XY polarization swapping information. In addition, the XY polarizations may be swapped by swapping adaptive equalization input data or adaptive equalization output data itself between the X polarization side and the Y polarization side without swapping the tap coefficients in the adaptive equalization circuit 1 or the XY polarizations may be swapped at the output of the data decoding unit 4c. In the case of the latter, the reference signals to be compared between X and Y in the carrier phase recovery circuit 3 need to be swapped for phase comparison.

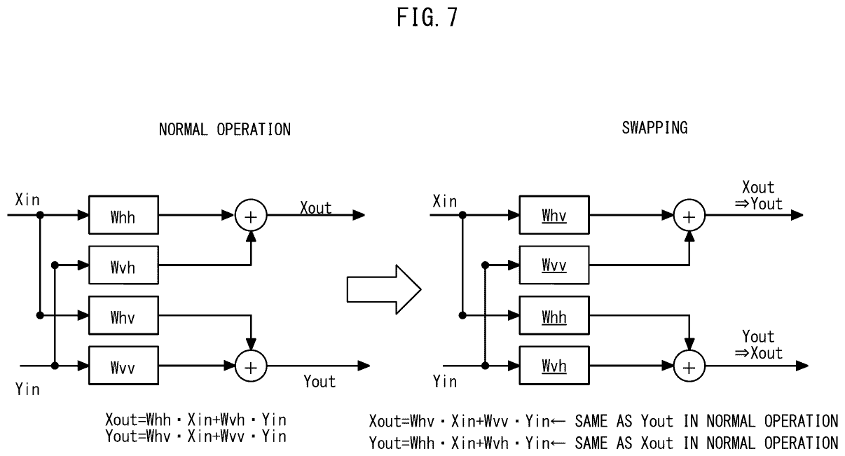

FIG. 7 is a diagram for describing an XY polarization swapping operation. A relationship between input and output during normal operation of the digital filter 6 of the adaptive equalization circuit 1 which sets tap coefficients is shown in the following equations.

$$Xout = Whh \cdot Xin + Wvh \cdot Yin$$

$$Yout = Whv \cdot Xin + Wvv \cdot Yin$$

If the XY polarization data is determined to be swapped by the XY polarization swapping information from the decoding circuit 4, a signal to be output as Xout and a signal to be output as Yout in normal operation can be easily swapped by swapping the tap coefficients. The tap coefficients are swapped as Whh→Whv, Wvh→Wvv, Whv→Whh, and Wvv→Wvh. A relationship between input and output during swapping is shown in the following equations.

$$Xout = Whv \cdot Xin + Wvv \cdot Yin$$

$$Yout = Whh \cdot Xin + Wvh \cdot Yin$$

In this case, Xout during swapping is the same as Yout during normal operation and Yout during swapping is the same as Xout during normal operation. In other words, XY polarization data can be swapped by swapping tap coefficients.

Note that XY polarization swapping can also be done by swapping the input data or the output data itself, as described above. However, for implementation reasons, swapping the tap coefficients enables processing on the circuits to be performed significantly easier. Accordingly, the adaptive equalization circuit 1 can operate more appropriately with respect to X polarization data and Y polarization data.

The XY inter-polarization skew information can be measured when establishing frame synchronization during the frame synchronization described above. The XY inter-polarization skew can be obtained by comparing a frame signal detected from the X polarization data and a frame signal detected from the Y polarization data. The adaptive equalization circuit 1 receives feedback of the XY inter-polarization skew information and compensates for the inter-polarization skew by adjusting the tap coefficients of the filters based on the XY inter-polarization skew information.

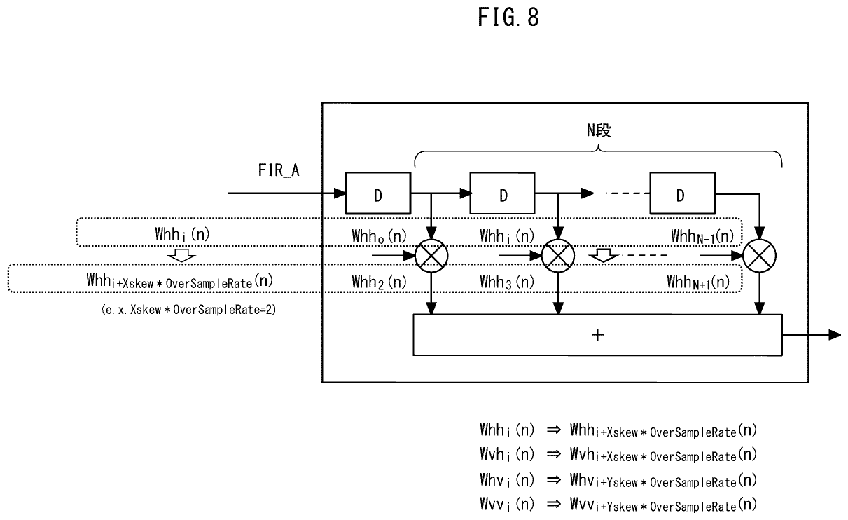

FIG. 8 is a diagram for describing a compensation operation of an XY inter-polarization skew. When compensating for an XY inter-polarization skew in the adaptive equalization circuit 1, the tap coefficients of the FIR filters in FIG. 5 are changed to the tap coefficients illustrated in FIG. 8. In FIG. 8, only FIR_A is illustrated as an example. Output of the digital filter 6 can be advanced or retarded by shifting the order of tap coefficients. The following changes in the tap coefficients mean shifting the order of the tap coefficients.

$${Whh}_{i} ( n ) \to {Whh}_{( i + Xskew * OverSampleRate )} ( n )$$

$${Wvh}_{i} ( n ) \to {Wvh}_{( i + Xskew * OverSampleRate )} ( n )$$

$${Whv}_{i} ( n ) \to {Whv}_{( i + Yskew * OverSampleRate )} ( n )$$

$${Wvv}_{i} ( n ) \to {Wvv}_{( i + Yskew * OverSampleRate )} ( n )$$

The subscript i denotes a tap number, where i=0 to N−1 in the case of an N-stage filter. Reference character n indicates an order in which the tap coefficients are updated. Xskew denotes a parameter indicating a shift amount of X polarization data. Yskew denotes a parameter indicating a shift amount of Y polarization data. OverSampleRate denotes an over-sampling rate. Xskew*OverSampleRate indicates a shift amount in over-sampling of X polarization data. Yskew*OverSampleRate indicates a shift amount in over-sampling of Y polarization data. For example, in a case of two samples per symbol, shifting one symbol means shifting taps by two. The example of FIR_A in FIG. 8 illustrates a case of a two-sample shift. Note that since the number of tap coefficients is finite, shifting the tap coefficients will result in taps for which no values exist, in which case they are zero-filled. In the example in FIG. 8, Whh_{N}(n)=0 and Whh_{N+1}(n)=0. Based on the XY inter-polarization skew information, the numbers of the tap coefficients are shifted in each filter to compensate for the XY inter-polarization skew.

Since the skew between the X polarization data and the Y polarization data is compensated for in the tap coefficient update operation of the adaptive equalization circuit 1 due to the changes made to the tap coefficients described above, the adaptive equalization circuit 1 can operate even more appropriately with respect to X polarization data and Y polarization data.

IQ swap information is information indicating an uncertainty of carrier phase synchronization in the carrier phase recovery circuit 3. When phase synchronization is not performed correctly, sign inversion in the I axis and the Q axis or swapping of I coordinate values and Q coordinate values will occur. In general, the presence or absence of IQ swaps can be determined by matching against expected values.

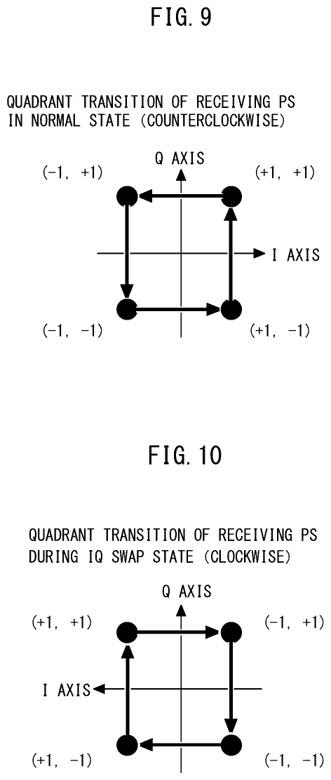

FIGS. 9 and 10 are diagrams for describing an IQ swap. In the diagrams, the I axis and the Q axis represent axes of a carrier. (I coordinate, Q coordinate)=(+1, +1) (first quadrant), (I coordinate, Q coordinate)=(−1, +1) (second quadrant), (I coordinate, Q coordinate)=(−1, −1) (third quadrant), (I coordinate, Q coordinate)=(+1, −1) (fourth quadrant) and a PS that transitions counterclockwise are sent as transmitted PS data. FIG. 9 illustrates a transition of quadrants of a PS when an IQ swap has not occurred and an orientation of the transition is counterclockwise.

FIG. 10 illustrates a transition of quadrants of a PS when an IQ swap has occurred and an orientation of the transition is clockwise. In other words, when an IQ swap of carriers occurs (when positive and negative of the I axis are inverted), the received coordinate values are (I coordinate, Q coordinate)=(+1, +1) (first quadrant), (I coordinate, Q coordinate)=(+1, −1) (fourth quadrant), (I coordinate, Q coordinate)=(−1, −1) (third quadrant), (I coordinate, Q coordinate)=(−1, +1) (second quadrant) and the transition is clockwise. For example, FIG. 10 illustrates a case where positive and negative of the I axis are inverted in reception. In the decoding circuit 4, after the true frame position is detected, the state detecting unit 4b obtains information on the IQ swap described above.

The IQ swap information is fed back to the carrier phase recovery circuit 3 to be used to successfully achieve synchronization using a known pattern when adopting the phase synchronization of the known-pattern comparison type in a carrier phase recovery operation. In other words, the carrier phase recovery circuit 3 compensates for an IQ swap by receiving feedback of the IQ swap information and adjusting coordinate data of a referenced known pattern based on the IQ swap information. Specifically, based on the IQ swap information, either an expected value of the known pattern on the receiver side is sign-reversed on the I axis or the Q axis, or the I coordinate value and the Q coordinate value are swapped.

The data decoding unit 4c finally decodes the X polarization data and the Y polarization data and outputs X polarization decoded data and Y polarization decoded data, respectively.

Note that in the configuration example in FIG. 3, the pseudo-frame signal generation circuit 5 is placed in a stage preceding the adaptive equalization circuit 1. However, if the adaptive equalization circuit 1 can in some way know the position of the head of the data section or the position of the PS, then the pseudo-frame signal generation circuit 5 can be placed in the stage following the adaptive equalization circuit 1.

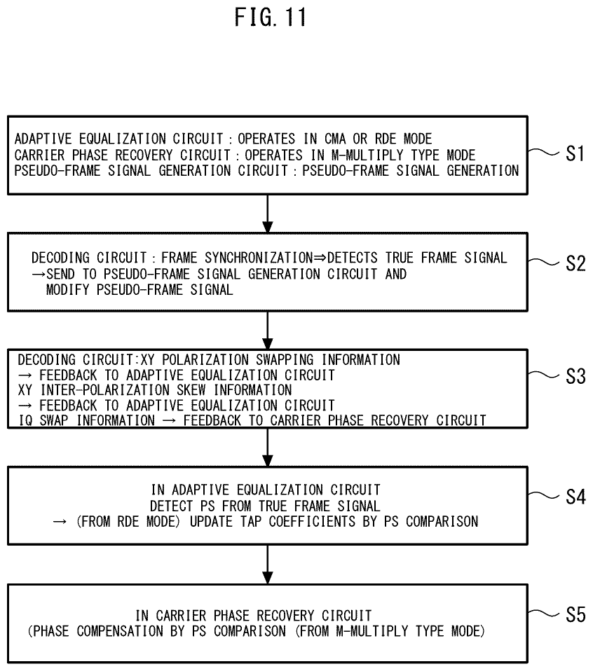

FIG. 11 is a flowchart illustrating operations of the adaptive equalization device according to the embodiment. Time-sequential operations of the adaptive equalization device 40 described above will now be described.

Step S1: At the start of reception of a received signal, the frame synchronizing unit 4a has not yet generated a true frame signal from an output signal of the digital filter 6. Therefore, the tap coefficient update circuit 7 of the adaptive equalization circuit 1 operates with a tap coefficient update algorithm of a blind equalization method such as CMA or RDE mode to obtain tap coefficients so that the difference between an amplitude value of data and an amplitude value that the data is expected to assume is small. The adaptive equalization circuit 1 does not have a frame synchronization function with respect to input signals. The carrier phase recovery circuit 3 operates in the M-multiply type mode, superimposes a modulated data signal on one quadrant, and compensates for a difference from the phase of the carrier signal in the quadrant. In other words, the carrier phase recovery circuit 3 performs phase synchronization so that the difference between the phase of the signal superimposed on one quadrant of the IQ plane and the phase that the superimposed signal should assume is small by multiplying the output signal of the digital filter 6 by M. The pseudo-frame signal generation circuit 5 generates a pseudo-frame signal and sequentially supplies the pseudo-frame signal to the adaptive equalization circuit 1, the frequency offset compensation circuit 2, the carrier phase recovery circuit 3, and the decoding circuit 4.

Step S2: The decoding circuit 4 performs frame synchronization by differential decoding. Accordingly, a true frame signal is detected. The synchronization pattern is about 16 symbols. A difference between the detected true frame signal and the pseudo-frame signal generated by the pseudo-frame signal generation circuit 5 is notified to the pseudo-frame signal generation circuit 5 and the pseudo-frame signal is corrected.

Step S3: The decoding circuit 4 detects and feeds back XY polarization swapping information and XY inter-polarization skew information to the adaptive equalization circuit 1 and detects and feeds back IQ swap information to the carrier phase recovery circuit 3.

Step S4: The adaptive equalization circuit 1 detects a PS from received data based on the true frame signal and uses the PS to update tap coefficients. A transition of the tap coefficient update algorithm is made from the RDE mode (blind equalization method) to the PS comparison mode (reference signal comparison equalization method). Furthermore, the XY polarization swapping information and the XY inter-polarization skew information from the decoding circuit 4 are used to optimize X polarization data and Y polarization data and more appropriate tap coefficients are calculated. In other words, after the frame signal is generated, the tap coefficient update circuit 7 receives the frame signal as feedback, detects a known signal from the data based on the frame signal, and updates the tap coefficients so that a difference between the detected known signal and the true value of the known signal becomes smaller.

Step S5: The carrier phase recovery circuit 3 detects a PS from the received data based on the true frame signal and uses the PS in a phase compensation operation based on PS comparison. Accordingly, a transition of the phase synchronization method is made from an operation in the M-multiply type mode to an operation in the PS comparison type mode (known-pattern comparison type). In other words, the carrier phase recovery circuit 3 receives the frame signal as feedback, detects a known signal from the data based on the frame signal, and performs phase synchronization so that a difference between a phase of the detected known signal and a phase of the true value of the known signal becomes smaller.

From the above, the adaptive equalization circuit 1 can comprehend the position of the PS by obtaining a frame signal in the decoding circuit 4 in the subsequent stage without having to provide a frame synchronization function with respect to input signals. Subsequently, a transition can be made to a highly accurate coefficient update method using the PS as a reference signal. In addition, the carrier phase recovery circuit 3 can also make a transition to a highly accurate phase synchronization method of the known-pattern comparison type which uses the detected PS as a known signal.

### REFERENCE SIGNS LIST

1 adaptive equalization circuit; 3 carrier phase recovery circuit; 4 decoding circuit; 4a frame synchronizing unit; 4b state detecting unit; 5 pseudo-frame signal generation circuit; 6 digital filter; 7 tap coefficient update circuit; 10 receiving optical module; 30 chromatic dispersion compensation circuit; 40 adaptive equalization device; 100 receiver

1. An adaptive equalization device comprising:
adaptive equalization circuitry;
decoding circuitry including a frame synchronizing circuitry; and
pseudo-frame signal generation circuitry generating a pseudo-frame signal,
wherein a frame initially generated is the pseudo-frame signal generated by the pseudo-frame signal generation circuitry,
the pseudo-frame signal is used as a trigger to start operation of the adaptive equalization circuitry and as a reference signal when performing signal processing in the decoding, circuitry,
the adaptive equalization circuitry includes a digital filter compensating for polarization fluctuation of at least two polarization data using a filter with tap coefficients set, and
tap coefficient update circuitry,
a synchronization pattern is inserted in a head of each frame of the polarization data as a known signal,
a pilot signal is inserted in a head of each subframe constituting the frame of the polarization data as a known signal,
before the frame synchronizing circuitry generates a frame signal from an output signal of the digital filter, the tap coefficient update circuitry obtains the tap coefficients by a blind equalization method so that a difference between an amplitude value of the data and an amplitude value that the data is expected to assume becomes smaller, and
after the frame signal is generated, the tap coefficient update circuitry receives the frame signal as feedback, detects the known signal from the data based on the frame signal, and updates the tap coefficients by a reference signal comparison equalization method so that a difference between the detected known signal and the true value of the known signal becomes smaller.

2. The adaptive equalization device according to claim 1,
wherein after the frame signal is generated, the pseudo-frame signal generation circuitry receives feedback of the frame signal and corrects the pseudo-frame signal to the frame signal, and the tap coefficient update circuitry detects a head position of the frame using the corrected pseudo-frame signal and detects the known signal based on the head position.

3. The adaptive equalization device according to claim 1, further comprising:
state detecting circuitry detecting whether polarization is swapped or not as polarization swapping information from an output signal of the frame synchronizing circuitry,
wherein the adaptive equalization circuitry receives feedback of the polarization swapping information and compensates for polarization swapping by adjusting the tap coefficients based on the polarization swapping information.

4. The adaptive equalization device according to claim 1, further comprising
state detecting circuitry detecting a skew between polarizations from an output signal of the frame synchronizing circuitry as inter-polarization skew information,
wherein the adaptive equalization circuitry receives feedback of the inter-polarization skew information and compensates for an inter-polarization skew by adjusting the tap coefficients based on the inter-polarization skew information.

5. The adaptive equalization device according to claim 1, further comprising:
carrier phase recovery circuitry provided between the adaptive equalization circuitry and the frame synchronizing circuitry and performing phase synchronization between IQ axes of the data and IQ axes of a carrier signal,
wherein before the flame signal is generated, the carrier phase recovery circuitry performs phase synchronization so that a difference between a phase of a signal superimposed on one quadrant of an IQ plane and a phase that the superimposed signal should assume becomes smaller by multiplying an output signal of the digital filter by M, and
after the flame signal is generated, the carrier phase recovery circuitry receives the frame signal as feedback, detects the known signal from the data based on the frame signal, and performs phase synchronization so that a difference between a phase of the detected known signal and a phase of a true value of the known signal becomes smaller.

6. The adaptive equalization device according to claim 5, further comprising state detecting circuitry detecting IQ swap information for each polarization data from an output signal of the frame synchronizing circuitry,
wherein the carrier phase recovery circuitry compensates for an IQ swap by receiving feedback of the IQ swap information and adjusting coordinate data of a referenced known pattern based on the IQ swap information.

7. A receiver comprising:
a receiving optical module converting a received optical signal into the data;
chromatic dispersion compensation circuitry compensating for distortion caused by chromatic dispersion of the data; and
the adaptive equalization device according to claim 1 compensating for polarization fluctuation of an output signal of the chromatic dispersion compensation circuitry.

8. An adaptive equalization method comprising:
compensating for polarization fluctuation of at least two polarization data by a digital filter with tap coefficients set, wherein a synchronization pattern is inserted in a head of each frame of the polarization data as a known signal, and a pilot signal is inserted in a head of each subframe constituting the frame of the polarization data as a known signal;
before frame synchronizing circuitry generates a frame signal from an output signal of the digital filter, obtaining the tap coefficients by a blind equalization method so that a difference between an amplitude value of the data and an amplitude value that the data is expected to assume becomes smaller, by tap coefficient update circuitry; and
after the frame signal is generated, receiving the frame signal as feedback, detecting the known signal from the data based on the frame signal, and updating the tap coefficients by a reference signal comparison equalization method that a difference between the detected known signal and the true value of the known signal becomes smaller, by the tap coefficient update circuitry,
wherein the frame initially generated is a pseudo-frame signal generated by pseudo-frame signal generation circuitry, and
the pseudo-frame signal is used as a trigger to start operation of adaptive equalization circuitry including the digital filter and the tap coefficient update circuitry, and as a reference signal when performing signal processing in decoding circuitry including the frame synchronizing circuitry.
